(19) United States
(12) Patent Application Publication
(10) Pub. No.: US 2026/0367834 A1
(43) Pub. Date: Nov. 19, 2026

(54) CONTROL DEVICE, DATA STORAGE DEVICE AND COMPUTING SYSTEM

(71) Applicant: SK hynix Inc., Icheon-si (KR)

(72) Inventor: Dong Hun JEONG, Icheon-si (KR)

(21) Appl. No.: 19/284,012

(22) Filed: Jul. 29, 2025

(30) Foreign Application Priority Data
May 19, 2025 (KR) 10-2025-0064294

(51) Int. Cl. G06F 3/06

(52) U.S. Cl. CPC G06F 3/0659; G06F 3/0604; G06F 3/0679

(57) ABSTRACT

The management of information on accesses to addresses according to commands inputted through a plurality of command paths is disclosed. The update sequence of the inputted addresses is arranged on the basis of whether the inputted addresses are included in previously stored access information, and updates are performed according to an arranged sequence. Therefore, it is possible to provide measures capable of accurately and efficiently managing access information while preventing an error when updating the access information.

### CROSS-REFERENCE TO RELATED APPLICATION

The present application claims priority under 35 U.S.C. § 119(a) to Korean Patent Application No. 10-2025-0064294 filed in the Korean Intellectual Property Office on May 19, 2025, which is incorporated herein by reference in its entirety.

### BACKGROUND

### 1. Technical Field

Embodiments of the present disclosure relate to a control device, a data storage device and a computing system.

### 2. Related Art

A data storage device may store data or read stored data and provide the read data to an external device according to a request from the external device. Depending on an interface through which the data storage device communicates with the external device or the type of memory included in the data storage device, the time required for the data storage device to process a request from the external device may differ.

In order to more efficiently process a request from the external device, the data storage device may manage access frequency information or recent usage information for data in accordance with the request from the external device. Overhead, however, may increase because the data storage device manages the access frequency information or the recent usage information by the external device, and in some cases the accuracy of the information may decrease.

In order to improve the operational performance of the data storage device, measures capable of efficiently and accurately managing information according to access from an external device while minimizing increases in overhead are needed.

### SUMMARY

Objects of embodiments of the disclosure are not limited to those set forth herein, and other unmentioned objects would be apparent to one of ordinary skill in the art from the following description.

Embodiments of the present disclosure are directed to providing measures for a data storage device to accurately and efficiently manage recent usage information of data according to a request from an external device.

In an embodiment, a data storage device may include: a memory; a controller configured to receive commands through an N (N is an integer satisfying N≥2) number of command paths and to control the operation of the memory; and a tracker module configured to store recent usage information of addresses according to the commands by updating the stored recent usage information, wherein an update sequence for at least two addresses is determined on the basis of whether each of the at least two addresses received through the N number of command paths is included in the stored recent usage information.

In an embodiment, a control device may include: a register configured to store recent usage information of an N number of addresses according to an N number of commands received through an N (N is an integer satisfying N≥2) number of command paths; and a tracking circuit configured to determine whether the N number of addresses are included in the recent usage information and an update sequence of the N number of addresses, and to update the recent usage information according to the update sequence to reflect the N number of addresses in the updated recent usage information.

In an embodiment, a computing system may include: a host device; and a data storage device configured to receive commands through an N number of command paths from the host device, store recent usage information of addresses according to the commands, and update the recent usage information according to an update sequence arranged on the basis of whether the addresses according to the commands simultaneously received through at least two of the N number of command paths are included in the recent usage information.

According to embodiments of the present disclosure, it is possible to efficiently and accurately manage recent usage information of data stored in a data storage device according to an access of the data by an external device.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a diagram illustrating an example of a schematic configuration of a data storage device according to embodiments of the present disclosure.

FIG. 2 is a diagram illustrating an example of a schematic configuration of a tracker module according to embodiments of the present disclosure.

FIG. 3 is a diagram illustrating an example of a data structure of recent usage information managed by a tracker module according to an embodiment of the present disclosure.

FIG. 4 is a diagram illustrating a detailed configuration of a tracker module according to an embodiment of the present disclosure.

FIG. 5 to FIG. 7 are diagrams illustrating examples of schemes in which a push signal generation circuit included in a tracker module arranges an update sequence according to the embodiments of the present disclosure.

FIG. 8 is a diagram illustrating an example of a method in which a tracker module updates recent usage information according to embodiments of the present disclosure.

FIG. 9 and FIG. 10 are diagrams illustrating detailed examples of a process in which a tracker module updates recent usage information according to embodiments of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings. Further, in the following description of examples or embodiments of the present disclosure, detailed descriptions of well-known functions and components incorporated herein will be omitted when it is determined that the description may make the subject matter in some embodiments of the present disclosure more unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, or manufacturing methods, these terms may be used to describe non-consecutive or non-sequential processes or operations unless the term “directly” or “immediately” is used together.

In addition, when any dimensions, relative sizes etc. are mentioned, it should be considered that numerical values for elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

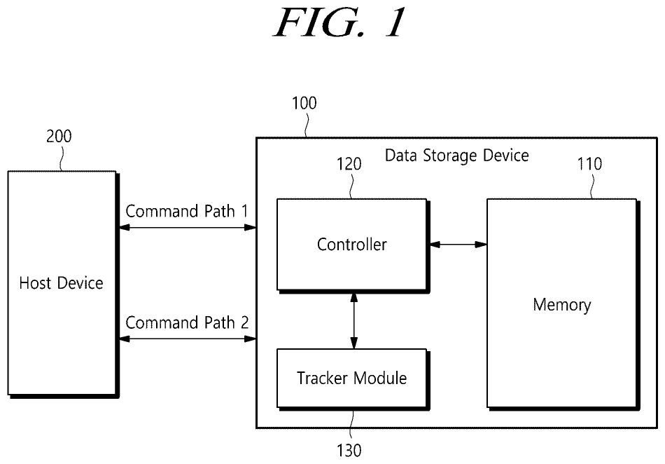

FIG. 1 is a diagram illustrating an example of a schematic configuration of a data storage device 100 according to embodiments of the present disclosure.

Referring to FIG. 1, a data storage device 100 may include at least one memory 110. The data storage device 100 may include a controller 120 that controls the operation of the memory 110. The data storage device 100 may include a tracker module 130 that monitors access to the memory 110 and manages information related to memory access. The may be located outside the controller 120, as in FIG. 1, or as the case may be, the tracker module 130 may be integrated with the controller 120.

The type of the memory 110 may vary. The memory 110 may be, for example, volatile memory such as DRAM, SDRAM, DDR SDRAM and LPDDR SDRAM, but embodiments of the present disclosure are not limited thereto. The memory 110 may be nonvolatile memory such as NAND flash memory, 3D NAND flash memory and NOR flash memory. In some embodiments, one part of the memory 110 included in the data storage device 100 may be volatile memory, and the other part may be nonvolatile memory.

The memory 110 may be one of various types of memory such as resistive RAM, phase change memory, magnetoresistive memory, ferroelectric memory and spin transfer torque memory. In other embodiments, the memory 110 may be processing-in-memory or compute-in-memory that includes a computation function or a data processing function.

The controller 120 may control the operation of the memory 110 on the basis of a command received from a device located outside of the data storage device. The controller 120 may control the operation of the memory 110 on the basis of an internally generated command.

The controller 120 may transmit to the memory 110 a command, an address, data, etc. for controlling the operation of the memory 110. For example, the controller 120 may control an operation of writing data to the memory 110. The controller 120 may control an operation of reading data written to the memory 110. Depending on the type of the memory 110, the controller 120 may control a refresh operation or an erase operation on data written to the memory 110. The controller 120 may perform an operation of detecting and correcting an error in data read from the memory 110. In some embodiments, the operation of correcting an error may be performed inside the memory 110.

The controller 120 may control the operation of the memory 110 while communicating with a device located outside the data storage device 100. For example, the data storage device 100 may be a device that operates while communicating with an external device using an CXL (Compute Express Link) standard. For example, the controller 120 may control the operation of the memory 110 while communicating with the external device according to the CXL standard. In addition, and as the case may be, the controller 120 may communicate with the external device using various interfaces such as PCIe.

The controller 120 may control the operation of the memory 110 on the basis of a command received from an external host device 200.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, a radio frequency identification (RFID) device, a mobility device (e.g., a vehicle, a robot or a drone) capable of traveling under human control or autonomous driving, etc. Alternatively, the host device 200 may be a virtual/augmented reality device that provides a 2D or 3D virtual reality image or augmented reality image. In addition to the examples described above, the host device 200 may be any one of various electronic devices that requires the data storage device 100 to be capable of storing data for data processing.

The host device 200 may include at least one operating system. The operating system may manage and control overall functions and operations of the host device 200, and may control an interoperation between the host device 200 and the data storage device 100. An operating system may be classified into a general operating system and a mobile operating system depending on the mobility of the host device 200.

The controller 120 and the host device 200 may be devices that are separated from each other, or the controller 120 and the host device 200 may be implemented by being integrated into one device. Hereunder, for the sake of convenience in explanation, examples are described in which the controller 120 and the host device 200 are devices that are separated from each other.

The controller 120 may communicate with the host device 200 through an N (where N is an integer satisfying N≥2) number of command paths. The data storage device 100 may include N number of ports corresponding to an N number of command paths, respectively. Separate commands may be transmitted and received through the N number of command paths, respectively. For example, in FIG. 1, a read command and a write command may be transmitted and received through a first command path and a second command path, respectively. Alternatively, a read command may be transmitted and received through one of a first command path and a second command path, and a write command may be transmitted and received through the other command path.

Commands to be transmitted and received through the N number of command paths, respectively, may be transmitted and received simultaneously and independently. The data storage device 100 may control the operation of the memory 110 according to commands received through the N number of command paths, respectively. The data storage device 100 may provide the host device 200 with processing results according to the commands received through the N number of command paths, respectively.

The tracker module 130 may track and manage an address accessed by the host device 200 in the course in which a command is processed by the controller 120. The tracker module 130 may manage access frequency information or recent usage information for data accessed by the host device 200. The tracker module 130 may manage information related with an access to an address where the data is stored.

Because processing for commands may be performed simultaneously while the commands are transmitted and received through the N number of command paths, the tracker module 130 may track and manage an address according to each of the commands transmitted and received through the N number of command paths. The tracker module 130 may store and manage access-related information according to address tracking, inside or outside the tracker module 130.

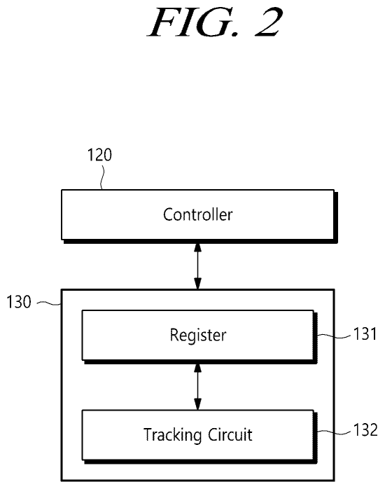

FIG. 2 is a diagram illustrating an example of a schematic configuration of a tracker module 130 according to embodiments of the present disclosure.

Referring to FIG. 2, a tracker module 130 may include, for example, a register 131 and a tracking circuit 132. As in the example illustrated in FIG. 2, the register 131 and the tracking circuit 132 may be disposed separately from the controller 120. Alternatively, the register 131 and the tracking circuit 132 may be integrated into the controller 120. Alternatively, at least a part of the tracker module 130 may be implemented in the form of a chiplet and provided as a structure connected to a control logic, an interface, etc. included in the controller 120.

The register 131 may store information related to access to an address according to a command received from the host device 200. The type of the access-related information stored in the register 131 or the data structure of the access-related information may vary.

Hereinafter, an example in which recent usage information, which is access-related information for a recently accessed address, will be described as an example. Such an example may also be applied where various information due to an access by the host device 200 is tracked and managed in other embodiments of the present disclosure. In addition, although the described example illustrates recent usage information stored in the form of a linked list array, recent usage information also may be stored in other types of data structures.

The tracking circuit 132 may track an address according to a command from the host device 200, in which the command is received and processed. The tracking circuit 132 may update and manage recent usage information stored in the register 131. The tracking circuit 132 may track and manage an address according to each of commands received through an N number of command paths.

The tracking circuit 132 may check whether an address according to a command received through each of the N number of command paths is included in recent usage information stored in the register 131.

When an address is included in the recent usage information, the tracking circuit 132 may update the recent usage information so that the address becomes the most recently accessed address in the recent usage information.

When an address is not included in the recent usage information, the tracking circuit 132 may add the address to the recent usage information, and may update the recent usage information so that the address becomes the most recently accessed address. When the capacity of the register 131 is insufficient due to the recent usage information stored in the register 131, the tracking circuit 132 may delete a part of previously stored addresses in order to add the address. For example, the tracking circuit 132 may delete, from the recent usage information, an address with the longest elapse time from its access time point. The new address may be added to a storage space that is created through the deletion, and may be managed as the most recently accessed address.

The data structure of recent usage information managed by the tracking circuit 132 and stored in the register 131 may vary. For example, the recent usage information may be stored as a linked list array structure to facilitate the management of the access sequence of addresses.

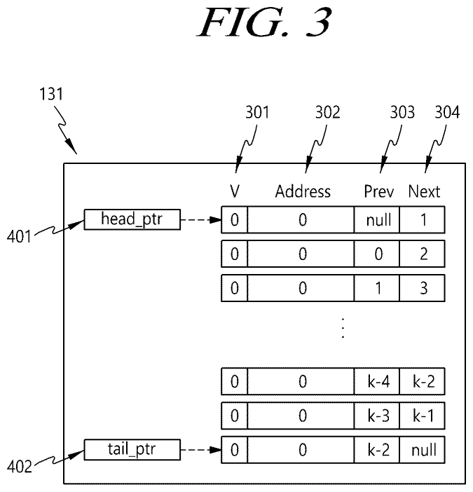

FIG. 3 is a diagram illustrating an example of a data structure of recent usage information managed by a tracker module according to an embodiment of the present disclosure.

Referring to FIG. 3, a data structure of recent usage information stored in a register 131 is configured as a linked list array, which may include a plurality of entries. For example, the data structure of recent usage information may include k number of entries.

Each of the k number of entries may include, for example, a validity field, an address field, a first pointer field and a second pointer field.

The validity field may indicate whether each entry is valid. For example, the validity field V may be 1 bit as indicated by 301. Before an address is added to the recent usage information, the validity field may have a value (e.g., 0) indicating that an entry is not valid. When a recently accessed address is added to an entry, the validity field may have a value (e.g., 1) indicating that the corresponding entry is valid, but other embodiments are not limited thereto.

The address field 302 may indicate an address according to recent access information. A recently accessed address is stored in the address field, and, when checking an address according to a new command, comparison with the address stored in the address field may be performed.

The first pointer field 303 may indicate the index of a previous entry. The second pointer field 304 may indicate the index of a next entry.

The data structure of the recent usage information may include a head pointer (see 401) that indicates a first entry among the respective entries of the recent usage information and a tail pointer (see 402) that indicates a last entry. The head pointer may indicate an entry that includes information on a most recently accessed address. The tail pointer may indicate an entry that includes information on an address with the oldest access time point from among addresses included in the recent usage information. When the number of addresses included in the recent usage information is smaller than the total number of the entries, the tail pointer may indicate any one among invalid entries.

In an initial state, all of the entries included in the recent usage information may be set to be invalid. As in the example illustrated in FIG. 3, the value of the validity field of each entry may be set to a value indicating that each entry is invalid. The head pointer may indicate the first entry, and the tail pointer may indicate the last kth entry. The values of the first pointer field and the second pointer field of each entry may be set according to the connection structure or predetermined relationship between the first entry and the kth entry. The values of the first pointer field and the second pointer field may be set according to the connection structure. If the connection structure does not exist, the values of the first pointer field and the second pointer field may set according to predetermined relationship.

When an address according to a command is received, a tracking circuit 132 of FIG. 2 may check the address and update the register 131 with recent usage information. Because addresses according to N number of commands may be received through the N number of command paths, the tracking circuit 132 may perform updates for an N number of addresses.

In order to perform the updates for the N number of addresses without errors, the tracking circuit 132 may sequentially compare the received addresses with previously stored recent usage information, may adjust the update sequence of the addresses (the sequence that the addresses are updated), and may perform an update of the recent usage information.

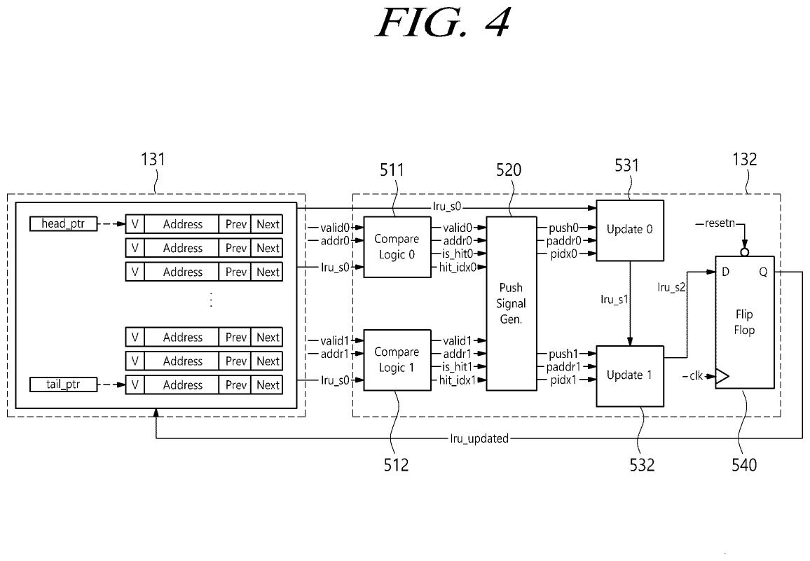

FIG. 4 is a diagram illustrating a detailed configuration of a tracker module according to an embodiment of the present disclosure.

Referring to FIG. 4, a tracker module 130 may include a register 131 and a tracking circuit 132. The tracking circuit 132 may include, for example, a comparison logic circuit 510, a push signal generation circuit 520, an update circuit 530, and a flip-flop circuit 540.

When a data storage device 100 receives commands from a host device 200 through an N number of command paths, the tracker module 130 may include an N number of comparison logic circuits 510. Outputs from the N number of comparison logic circuits 510 may be inputted to a single push signal generation circuit 520.

The tracker module 130 may include an N number of update circuits 530. The output of the push signal generation circuit 520 may be inputted to the N number of update circuits 530. The outputs of the N number of update circuits 530 may be inputted to the flip-flop circuit 540.

The example illustrated in FIG. 4 illustrates a comparison logic circuit 510 included in the tracker module 130 when the data storage device 100 receives commands from the host device 200 through two command paths, but embodiments of the present disclosure may also include commands transmitted and received through three or more command paths.

The tracker module 130 may include a first comparison logic circuit 511 and a second comparison logic circuit 512.

For example, the first comparison logic circuit 511 may receive an address according to a command inputted through a first command path. The first comparison logic circuit 511 may receive or check recent usage information stored in the register 131.

The second comparison logic circuit 512 may receive an address according to a command inputted through a second command path. The second comparison logic circuit 512 may receive or check recent usage information stored in the register 131.

Each of the first comparison logic circuit 511 and the second comparison logic circuit 512 may compare an address according to a command with an address according to the recent usage information, and may output detection information according to a comparison result. The detection information may include information that indicates an address or information that indicates whether an address is hit.

For example, each of the first comparison logic circuit 511 and the second comparison logic circuit 512 may output a hit value when an address according to a command is included in the recent usage information. Otherwise, each of the first comparison logic circuit 511 and the second comparison logic circuit 512 may output a miss value when an address according to a command is not included in the recent usage information.

The hit value or the miss value and information on an address outputted by each comparison logic circuit 510 may be inputted to the push signal generation circuit 520.

The push signal generation circuit 520 may determine the update sequence of the addresses on the basis of addresses and information indicating whether the corresponding addresses, received from the first comparison logic circuit 511 and the second comparison logic circuit 512, are hits.

For example, as a result of comparing addresses according to commands and addresses included in the recent usage information, the push signal generation circuit 520 may adjust an update sequence so that an update for an address included in the recent usage information is performed with priority over an update for an address not included in the recent usage information. A signal that indicates the adjusted update sequence may be referred to as a push signal. According to the push signal, an address that requires a push (an update) first may be indicated.

When an address inputted to the first comparison logic circuit 511 is included in the recent usage information stored in the register 131, and an address inputted to the second comparison logic circuit 512 is not included in the recent usage information stored in the register 131, the push signal generation circuit 520 may adjust an update sequence so that an update for the address inputted to the first comparison logic circuit 511 is performed first.

When an address inputted to the first comparison logic circuit 511 is not included in the recent usage information stored in the register 131, and an address inputted to the second comparison logic circuit 512 is included in the recent usage information stored in the register 131, the push signal generation circuit 520 may adjust an update sequence so that an update for the address inputted to the second comparison logic circuit 512 is performed first.

An error may occur when an address missed in a linked list array structure is updated first and the address of an entry indicated by the tail pointer is deleted. When the linked list array structure changes in this manner, an error may occur when updating an address according to another command for which a hit has occurred.

In order to prevent the update of a hit address from failing because of an earlier update of a missed address, the push signal generation circuit 520 manages the recent usage information in the linked list array structure by adjusting an update sequence according to whether addresses according to commands received through a plurality of command paths are hit.

The push signal generation circuit 520 may output addresses to the update circuit 530 according to an adjusted update sequence.

The first update circuit 531 may receive the recent usage information and an address that requires an update first according to the update sequence or a push signal that indicates the address. The first update circuit 531 may update recent usage information according to the recent usage information stored in the register 131 and the push signal, and output updated recent usage information to the second update circuit 532. The second update circuit 532 may update recent usage information on the basis of the recent usage information received from the first update circuit 531 and a push signal that indicates an update sequence.

When a plurality of update circuits 530 exist, the recent usage information updated by the last update circuit 530 may be provided to the flip-flop circuit 540.

The flip-flop circuit 540 may receive the updated recent usage information and a clock signal. In synchronization with the clock signal, the updated recent usage information may be stored in the register 131.

In this way, the recent usage information of addresses according to commands inputted through the plurality of command paths may be updated and managed by the tracker module 130. When updating recent usage information, by adjusting an update sequence according to whether an address is included in previously stored recent usage information, it is possible to prevent an error from occurring when updating recent usage information.

The push signal generation circuit 520 may adjust an update sequence in various ways and generate a push signal that indicates an adjusted update sequence.

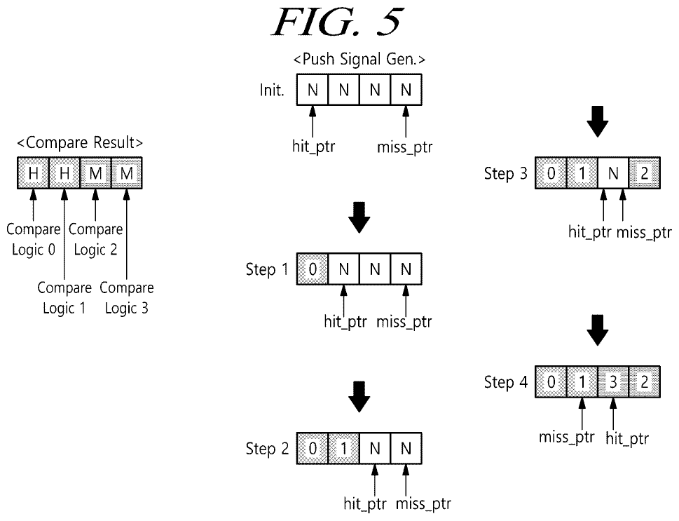

FIG. 5 to FIG. 7 are diagrams illustrating examples of schemes in which a push signal generation circuit included in a tracker module arranges an update sequence according to embodiments of the present disclosure.

As an example, referring to FIG. 5, commands are received through four command paths. As illustrated, four commands may be transmitted from a host device 200 to a data storage device 100 through four command paths. The data storage device 100 may receive four addresses according to the four commands, respectively.

Using a comparison logic circuit 510 of a tracker module 130, the four addresses are checked to determine if the addresses are included in previously stored recent usage information.

In FIG. 5, a first address and a second address among the four addresses are matched to addresses stored in the recent usage information (e.g., are hits) and a third address and a fourth address are not included in the stored recent usage information (e.g., are misses).

A push signal generation circuit 520 may generate a push signal using a hit pointer hit_ptr and a miss pointer miss_ptr. All of the values of the push signal may initially have a null value N. The hit pointer may indicate a first position (update turn) of the push signal, and the miss pointer may indicate a last position (update turn) of the push signal.

In Step 1, because the first address is a hit, the push signal generation circuit 520 may push a corresponding index to a position indicated by the hit pointer, and may increase the value of the hit pointer. In Step 2, because the second address is also hit, the push signal generation circuit 520 may push a corresponding index to a position indicated by the hit pointer, and may increase the value of the hit pointer.

An index that indicates an address hit in a comparison process by the comparison logic circuit 510 may be pushed by being arranged in normal order in the push signal.

In Step 3, because the third address is missed, the push signal generation circuit 520 may push a corresponding index to a position indicated by the miss pointer, and may increase the value of the miss pointer. In Step 4, because the fourth address is also missed, the push signal generation circuit 520 may push a corresponding index to a position indicated by the miss pointer, and may increase the value of the miss pointer.

An index that indicates an address missed in the comparison process by the comparison logic circuit 510 may be pushed by being arranged in reverse order in the push signal.

In FIG. 5, when the generation of the push signal is completed, the value of the hit pointer may be greater than the value of the miss pointer. In other examples, when the number of inputted addresses is smaller than the number of command paths, a push signal may be generated without the values of the hit pointer and the miss pointer intersecting in the push signal, and the value of the miss pointer may be equal to or greater than the value of the hit pointer.

In FIG. 5, according to the push signal outputted by the push signal generation circuit 520, updates may be performed in the sequence of the first address, the second address, the fourth address and the third address. Updates of the first address and the second address, which are hits, may be performed first.

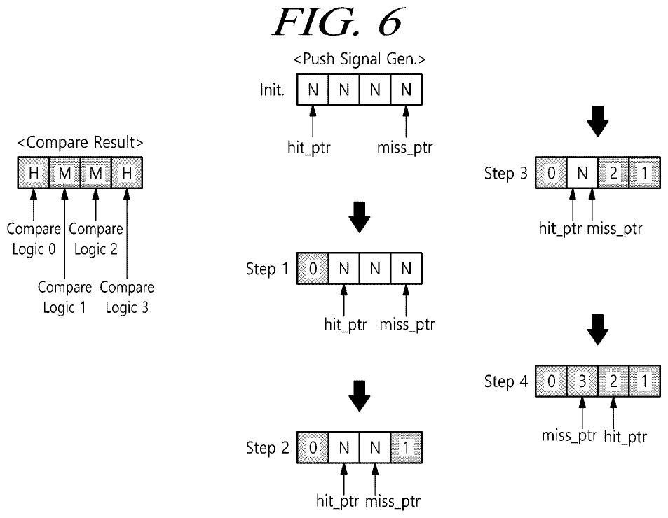

As another example, referring to FIG. 6, four addresses according to four commands are inputted in the sequence of hit, miss, miss and hit.

In an initialized state, the push signal generation circuit 520 may set the all values of a push signal to a null value and initialize positions that are indicated by the hit pointer and the miss pointer.

In Step 1, because a first address is hit, the push signal generation circuit 520 may push a corresponding index to a position indicated by the hit pointer, and may increase the value of the hit pointer.

In Step 2, because a second address is missed, the push signal generation circuit 520 may push a corresponding index to a position indicated by the miss pointer, and may increase the value of the miss pointer. In Step 3, because a third address is missed, the push signal generation circuit 520 may push a corresponding index to a position indicated by the miss pointer, and may increase the value of the miss pointer. Indexes that indicate missed addresses may be pushed to the push signal by being arranged in the reverse order of input order.

In Step 4, because a fourth address is hit, the push signal generation circuit 520 may push a corresponding index to a position indicated by the hit pointer, and may increase the value of the hit pointer. Because the corresponding index is pushed to the position indicated by the hit pointer, the update turns of the first address and the fourth address may precede the update turns of the second address and the third address. The value of the hit pointer and the value of the miss pointer may intersect or cross.

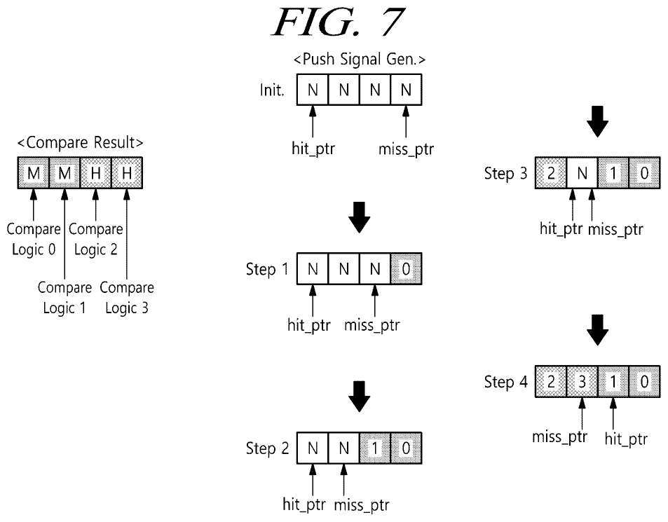

As still another example, referring to FIG. 7, first address and a second address are missed and a third address and a fourth address are hit.

In Step 1 and Step 2, because indexes that indicate the first address and the second address are pushed to positions indicated by the miss pointer, they may be pushed to the third position and the fourth position of the push signal. The sequence of an index that indicates the first address and an index that indicates the second address may be reversed and be pushed to the push signal. The value of the miss pointer is decreased so that the miss pointer may indicate a second position of the push signal.

In Step 3 and Step 4, because indexes that indicate the third address and the fourth address are pushed to positions indicated by the hit pointer, they may be pushed to the first position and the second position of the push signal. An index that indicates the third address and an index that indicates the fourth address may be pushed in normal order in the push signal. The value of the hit pointer is increased so that the hit pointer may indicate the third position of the push signal.

Even though hit addresses are inputted third and fourth, an update sequence may be provided by being arranged by the push signal generation circuit 520. Updates for hit addresses may be performed first. When managing recent usage information of a plurality of addresses according to a plurality of commands inputted through a plurality of command paths, it is possible to prevent an error from occurring due to whether sequential addresses are hits or misses by using an improved update sequence when updating the recent usage information.

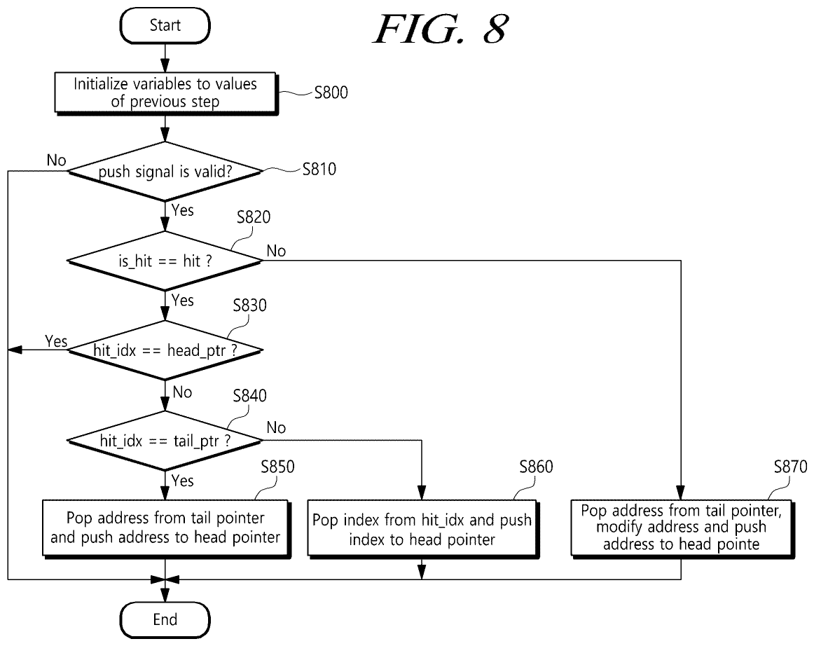

FIG. 8 is a diagram illustrating an example of a method in which a tracker module 130 updates recent usage information according to embodiments of the present disclosure.

Referring to FIG. 8, a tracker module 130 may initialize several variables related to previously stored recent usage information in order to update recent usage information (S800). For example, the tracker module 130 may set the value of each entry of stored recent usage information, such as the value of the head pointer, the value of the tail pointer, etc. to values updated in a previous step.

Upon receiving a plurality of addresses according to a plurality of commands through a plurality of command paths, respectively, the tracker module 130 may compare the plurality of addresses with the entries of stored recent usage information, and may output detection information according to the comparison. The tracker module 130 may arrange an update sequence according to whether the addresses included in the detection information are hits or misses. The tracker module 130 may generate a push signal that indicates the update sequence and check whether the push signal is valid (S810).

When the push signal is valid, the tracker module 130 may check whether an address indicated by an index included in the push signal corresponds to an address that is included in the recent usage information (S820). The tracker module 130 may check whether the corresponding address is hit.

When the corresponding address is included in the recent usage information, the tracker module 130 may check whether the head pointer indicates an entry including the corresponding address (S830). When the entry including the hit address is indicated by the head pointer, the tracker module 130 may maintain the recent usage information as it is without updating the recent usage information.

The tracker module 130 may check whether the entry including the hit address is indicated by the tail pointer (S840). The tracker module 130 may pop the address from the tail pointer and push the address to the head pointer (S850). The entry indicated by the tail pointer may be changed to be indicated by the head pointer. As an entry indicated by the head pointer is changed, an entry indicated by the tail pointer may be changed.

When the entry including the hit address is not indicated by the tail pointer, the tracker module 130 may pop the index of the corresponding entry and push the index to the head pointer (S860). The head pointer may indicate the entry including the hit address. As an entry indicated by the head pointer is changed, the value of the first pointer field or the second pointer field included in each entry may be changed.

When the address is not included in the recent usage information (is not hit), the tracker module 130 may pop the tail pointer, may modify an address and may push the address to the head pointer (S870). An entry indicated by the tail pointer may be indicated by the head pointer. The address included in the corresponding entry may be in a state in which it is modified. As the head pointer is changed, the tail pointer and the first pointer field and the second pointer field included in each entry may be changed.

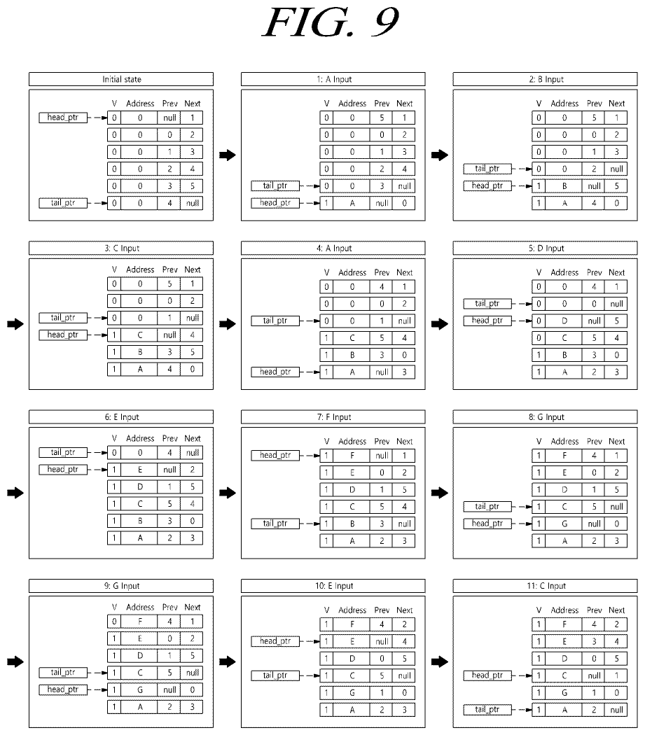

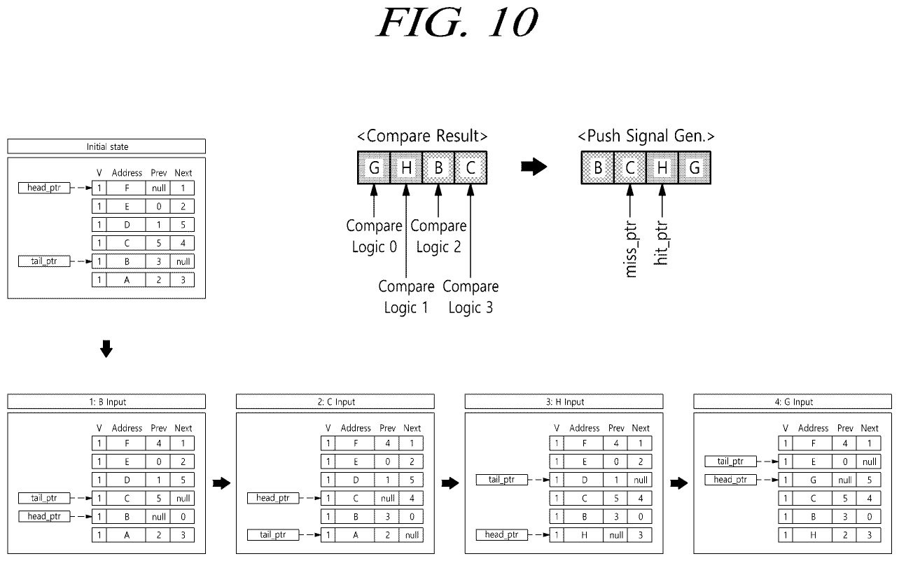

FIG. 9 and FIG. 10 are diagrams illustrating detailed examples of a process in which a tracker module 130 updates recent usage information according to embodiments of the present disclosure.

Referring to FIG. 9, six entries stored in the register 131 are illustrated as an example. In an initial state, all of the six entries may be invalid. The head pointer may indicate a first entry, and the tail pointer may indicate a sixth entry.

When an address A is inputted, because the address A is determined as a miss, the address A may be pushed to the entry indicated by the tail pointer, and the head pointer may indicate the corresponding entry. The first pointer field of the sixth entry may be changed to a null value, and the second pointer field may be changed to a value that indicates the first entry previously indicated by the head pointer. As the head pointer is changed, the tail pointer may be changed to indicate a fifth entry, and the second pointer field of the fifth entry may be changed to a null value.

Similarly, when a new address is inputted and is determined as a miss, the new address may be pushed to an entry indicated by the tail pointer. Entries indicated by the head pointer and tail pointer may be changed. As the head pointer and the tail pointer are changed, the value of the first pointer field or the second pointer field included in at least a part of the entries may be changed. In this way, addresses B and C may be inputted.

A linked list array may be configured in the sequence of addresses C→B→A. In this state, an address A may be inputted. Because the address A is already included, a hit may occur. The head pointer may be changed to indicate the entry where the address A is stored, and the values of the first pointer field and the second pointer field of some entries may be changed. A linked list array may be configured in the sequence of addresses A→C→B.

Addresses D, E and F, which are not included in the entries, may be inputted. Because all of the addresses D, E and F are determined as misses, each address may be pushed to an entry indicated by the tail pointer. A linked list array may be configured in the sequence of F→E→D→A→C→B.

An address G may be inputted in a state in which all the entries are valid. Because the address G is not included in the entries, the address G may be determined as a miss. The address B stored in an entry indicated by the tail pointer may be removed. The address G may be pushed to the corresponding entry, and the head pointer may indicate the corresponding entry. A linked list array may be configured in the sequence of G→F→E→D→A→C.

Recent usage information may be updated according to the input of a new address and whether the new address is a hit or a miss.

In this way, when updating recent usage information, an update is performed by arranging an update sequence depending on whether a plurality of addresses according to a plurality of commands inputted simultaneously are hit, and thus, it is possible to prevent a hit address from being updated incorrectly.

For example, referring to FIG. 10, all entries are valid in an initial state and a linked list array configured in the sequence of F→E→D→A→C→B is illustrated. In this state, addresses G, H, B and C may be inputted through command paths. The addresses G and H may correspond to misses, and the addresses B and C may correspond to hits. If the addresses G and H are updated first, then the address B of an entry indicated by the tail pointer could be evicted. Thereafter, when updating the address B, an index indicating the entry of the address B may be changed (because the address B is not included in an entry), which may cause an error.

In contrast, according to the embodiments of the present disclosure, as an update sequence is arranged, updates may be performed in the sequence of B, C, H and G.

Because the update of the address B is performed first, the head pointer and the tail pointer included in recent usage information may be changed, and the first pointer field and the second pointer field of some entries may be changed. A linked list array may be configured in the sequence of B→F→E→D→A→C.

The update of the address C is performed, and a linked list array may be configured in the sequence of C→B→F→E→D→A.

Thereafter, the update of the addresses H and G may be performed. The addresses H and G may be included in the recent usage information as the addresses of entries indicated by the tail pointer are evicted. The addresses B and C included in the previous recent usage information are maintained, and a linked list array may be configured in the sequence of G→H→C→B→F→E.

In this way, according to the embodiments of the present disclosure, when updating recent usage information of a plurality of addresses according to a plurality of commands inputted through a plurality of command paths, respectively, the recent usage sequence of addresses included in the recent usage information is prevented from being incorrectly changed according to an update sequence, and accurate recent usage information may be provided.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A data storage device comprising:
a memory;
a controller configured to receive commands through an N (N is an integer satisfying N≥2) number of command paths and to control an operation of the memory; and
a tracker module configured to store recent usage information of addresses according to the commands by updating stored recent usage information,
wherein an update sequence for at least two addresses is determined on the basis of whether each of the at least two addresses received through the N number of command paths is included in the stored recent usage information.

2. The data storage device according to claim 1, wherein the tracker module performs an update of an address from among the at least two addresses included in the stored recent usage information with priority over an update of an address from among the at least two addresses not included in the stored recent usage information.

3. The data storage device according to claim 1, wherein the tracker module comprises:
a comparison logic circuit configured to compare the at least two addresses with the stored recent usage information and output detection information indicating whether the at least two addresses are included in the stored recent usage information;
a push signal generation circuit configured to determine the update sequence of the at least two addresses on the basis of the detection information; and
an update circuit configured to update the stored recent usage information while sequentially including the at least two addresses according to the update sequence.

4. The data storage device according to claim 3, wherein the comparison logic circuit sequentially compares each of the at least two addresses with the stored recent usage information, outputs the detection information including a hit value for an address included in the stored recent usage information, and outputs the detection information including a miss value for an address not included in the stored recent usage information.

5. The data storage device according to claim 4, wherein the push signal generation circuit performs initialization so that a hit pointer indicates a first turn of the update sequence and a miss pointer indicates a last turn, pushes information on the address corresponding to the hit value at a turn indicated by the hit pointer according to the hit value and increases the value of the hit pointer, and pushes information on the address corresponding to the miss value at a turn indicated by the miss pointer according to the miss value and decreases the value of the miss pointer.

6. The data storage device according to claim 5, wherein, when the update sequence is determined, the value of the hit pointer is greater than the value of the miss pointer.

7. The data storage device according to claim 5, wherein the address according to the hit value is included in the update sequence in normal order, and the address according to the miss value is included in the update sequence in reverse order.

8. The data storage device according to claim 5, wherein
the update circuit updates a head pointer according to the hit value to indicate an entry including the address corresponding to the hit value among entries included in the stored recent usage information, and
the update circuit evicts an entry indicated by a tail pointer according to the miss value, stores the address corresponding to the miss value in the evicted entry, and updates the head pointer to indicate the entry in which the address corresponding to the miss value is stored.

9. The data storage device according to claim 3, wherein the comparison logic circuit comprises an N number of comparison logic circuits, and an N number of addresses according to the N number of commands inputted through the N number of command paths are inputted to the N number of comparison logic circuits, respectively.

10. The data storage device according to claim 9, wherein the update circuit comprises an N number of update circuits, and the addresses outputted by the N number of comparison logic circuits are inputted to the N number of update circuits, respectively, according to an update sequence arranged by the push signal generation circuit.

11. The data storage device according to claim 1, wherein
the stored recent usage information includes a plurality of entries, and
each of the plurality of entries includes a validity field that indicates whether each of the plurality of entries is valid, an address field that indicates an address included in each of the plurality of entries, a first pointer field that indicates a previous entry of each of the plurality of entries, and a second pointer field that indicates a next entry of each of the plurality of entries.

12. The data storage device according to claim 1, wherein a write command is transmitted through at least one of the N number of command paths, and a read command is transmitted through at least another one of the N number of command paths.

13. The data storage device according to claim 1, wherein the controller simultaneously processes at least two commands transmitted through the N number of command paths.

14. A control device comprising:
a register configured to store recent usage information of an N number of addresses according to an N number of commands received through an N (N is an integer satisfying N≥2) number of command paths; and
a tracking circuit configured to determine whether the N number of addresses are included in the recent usage information and an update sequence of the N number of addresses, and to update the recent usage information according to the update sequence to reflect the N number of addresses in the updated recent usage information.

15. The control device according to claim 14, wherein the tracking circuit comprises:
an N number of comparison logic circuits configured to compare the N number of respective addresses with the recent usage information and to output detection information indicating whether the N number of respective addresses are included in the recent usage information;
a push signal generation circuit configured to determine the update sequence of the N number of addresses on the basis of the detection information outputted by the N number of comparison logic circuits; and
an N number of update circuits configured to receive the N number of addresses, respectively, according to the update sequence and to update the recent usage information.

16. The control device according to claim 15, wherein each of the N number of comparison logic circuits receives each of the N number of addresses and the recent usage information;
outputs, when an inputted address is included in the recent usage information, the detection information including a hit value and an index value indicating an entry including the address included in the recent usage information to the push signal generation circuit; and
outputs, when the inputted address is not included in the recent usage information, the detection information including a miss value to the push signal generation circuit.

17. The control device according to claim 16, wherein the push signal generation circuit determines the update sequence so that an address corresponding to the hit value is included in a normal order and determines the update sequence so that an address corresponding to the miss value is included in a reverse order, and an address corresponding to the hit value is positioned with a higher priority than an address corresponding to the miss value.

18. The control device according to claim 17, wherein the N number of update circuits comprises:
a first update circuit configured to receive the recent usage information, receive information on an address according to the update sequence by the push signal generation circuit, and update the recent usage information so that the inputted address is included in the updated recent usage information; and
a second update circuit configured to receive the recent usage information outputted by the first update circuit, receive information on an address according to the update sequence by the push signal generation circuit, and update the recent usage information so that the inputted address is included in the updated recent usage information.

19. A computing system comprising:
a host device; and
a data storage device configured to receive commands through an N number of command paths from the host device, store recent usage information of addresses according to the commands, and update the recent usage information according to an update sequence arranged on the basis of whether the addresses according to the commands simultaneously received through at least two of the N number of command paths are included in the recent usage information.

20. The computing system according to claim 19, wherein the data storage device updates an address included in the recent usage information before an address not included in the recent usage information.
